(19) United States
(12) Patent Application Publication
(10) Pub. No.: US 2011/0276311 A1
(43) Pub. Date: Nov. 10, 2011

(54) METHOD FOR TESTING FUNCTIONALITY OF AN OPTICAL MEASURING DEVICE OF A MACHINE TOOL

(75) Inventor: ROLAND FINKLER, Erlangen (DE)

(73) Assignee: Siemens Aktiengesellschaft, Munchen (DE)

(21) Appl. No.: 13/185,004

(22) Filed: Jul. 18, 2011

Related U.S. Application Data
(63) Continuation of application No. 12/375,584, filed on Jan. 29, 2009.

(30) Foreign Application Priority Data
May 3, 2007 (DE) 10 2007 020 761.3

(51) Int. Cl. G06F 15/00

(52) U.S. Cl. 702/182

(57) ABSTRACT

In a method for testing functionality of an optical measuring device of a machine tool, optical measurement signals are acquired and converted into analog electrical signals, which are in turn supplied to an evaluation unit. The analog electrical signals are also supplied as test signals to a monitoring unit, which performa, upon initiation by a control device of the machine tool, a self-test of the monitoring unit by adjusting the test signals supplied to the monitoring unit such that a combination signal formed from the test signals is below the lower or above the upper threshold limit. It is then checked, if an error signal is transmitted to the control device of the machine tool, when the combination signal is below the lower or above the upper threshold limit, wherein failure to transmit an error signal indicates a malfunction of the monitoring unit.

### CROSS-REFERENCES TO RELATED APPLICATIONS

This application is a continuation of prior filed copending U.S. application Ser. No. 12/375,584, filed Jan. 29, 2009, the priority of which is hereby claimed under 35 U.S.C. §120 and which is the National Stage of International Application No. PCT/EP2008/055338, filed Apr. 30, 2008, which designated the United States and has been published as International Publication No. WO 2008/135495 and which claims the priority of German Patent Application, Serial No. 10 2007 020 761.3, filed May 3, 2007 pursuant to 35 U.S.C. 119(a)-(d).

The contents of U.S. application Ser. No. 12/375,584, International Application No. PCT/EP2008/055338 and German Patent Application, Serial No. 10 2007 020 761.3, are incorporated herein by reference in their entireties as if fully set forth herein.

### BACKGROUND OF THE INVENTION

The invention relates to a measurement arrangement having a measurement unit for detection of an operating variable of a machine, and having a control unit, which is connected to the measurement unit by means of a bidirectional digital data link, for controlling the machine, wherein the measurement unit has sensor means for detection of at least one analog measurement signal for the operating variable, and an evaluation unit for digitizing and evaluation of the analog measurement signal, as well as, at least partially, a monitoring unit for threshold-value checking of the analog measurement signal, and the data link is designed for transmission of digital measurement and/or monitoring information, transmitted by the evaluation unit and the monitoring unit, from the measurement unit to the control unit, and for transmission of a digital control command in order to initiate a self-test of the monitoring unit, from the control unit to the measurement unit.

By way of example, a measurement arrangement such as this is known from DE 102 44 583 A1. In this known measurement arrangement, a position of a moving part of a processing machine is detected as an operating variable. The instantaneous position of the part which, for example, is in the form of a linearly or rotationally moving rotor is required in the control unit in order to control the processing machine. In order to improve the reliability, the position is often detected redundantly. However, only a single measurement unit is provided in the measurement arrangement according to DE 102 44 583 A1, and comprises one monitoring unit in order to ensure the required reliability. The latter checks whether the analog measurement signals produced by the sensor means are within specific limits. In addition, the control unit can initiate a self-test of the monitoring unit, in which the analog measurement signals are replaced by a test potential such that, for example an upper threshold value is exceeded and the monitoring unit can be checked for its serviceability at that time. The provision of the test potential requires an additional voltage source. On the one hand, this is costly, on the other hand it does not allow comprehensive checking of the serviceability of the monitoring unit.

### SUMMARY OF THE INVENTION

The object of the invention is therefore to specify a measurement arrangement of the type referred to initially, which allows simple and nevertheless reliable checking of the measurement unit and in particular of the monitoring unit.

This object is achieved by a method for testing functionality of an optical measuring device of a machine tool, with the steps of acquiring optical measurement signals and converting the acquired optical measurement signals into analog electrical signals, supplying the analog electrical signals to an evaluation unit, supplying the analog electrical signals as test signals to a monitoring unit, performing, upon initiation by the control device, a self-test of the monitoring unit by adjusting the test signals supplied to the monitoring unit such that a combination signal formed from the test signals is below the lower or above the upper threshold limit, checking, if an error signal is transmitted to a control device of the machine tool, when the combination signal is below the lower or above the upper threshold limit, and indicating a malfunction of the monitoring unit if no error signal is transmitted. The amplification or attenuation of the analog measurement signal supplied as a test signal to the monitoring unit during the self-test can be changed for checking functionality of the monitoring unit.

The amplification or attenuation, as provided according to the invention, of the analog measurement signal during the self-test can be provided in a simple manner and thus at very low cost. In particular, the modification means according to the invention can be implemented by making use of component elements which are provided in any case in the measurement unit. For this purpose, the latter does need to be modified or upgraded slightly.

The serviceability of the monitoring unit can be checked more comprehensively by means of an appropriately amplified or attenuated analog measurement signal than by application of a test potential as is known from the prior art. The known method completely ignores dynamic processes. In contrast, the dynamics of the analog measurement signal are also included for self-testing of the monitoring unit in the measurement arrangement according to the invention.

In one advantageous variant, the modification means are designed for multistage or continuous amplification or attenuation of the analog measurement signal. This also results in more accurate checking of the serviceability of the monitoring unit. For example, this makes it possible accurately to determine the lower and/or upper threshold value from which the monitoring unit responds, and sends a fault message to the control unit, by means of successive setting of different attenuation or gain factors or by means of a selected time profile for the attenuation or gain factor. This allows an incipient malfunction, which at this stage is still not critical, of the monitoring unit to be identified at a very early stage, thus allowing countermeasures to be initiated more objectively and in particular also at an appropriate time.

Furthermore, it is preferably possible for the modification means to comprise a switchable-gain amplifier. This allows the level of the analog measurement signal to be influenced very easily and in a desired manner during the self-test. In particular, a resistor which can be connected or a resistor bank which can be connected can additionally be provided on an amplifier which is provided in any case, in order to vary the gain factor.

In another advantageous variant, the sensor means comprise an optical sine/cosine transmitter having at least one light source and the modification means comprise a light source drive unit for variable setting of the light intensity produced by the light source or sources. A sine/cosine transmitter such as this in particular has two optical sampling units which produce two approximately sinusoidal analog output signals with a phase offset of 90°. The sums of their squares have a constant value, which is governed by the light intensity or intensities of the one or possibly two light source or sources that is or are used. When this sum signal is evaluated, its level can be influenced without any problems via the light intensities which are predetermined on the input side. On the basis of the variation, which can be accomplished easily, of the transmission light intensity or intensities of the light source or sources, the monitoring unit thus specifically has a signal level applied to it which is so low or so high that, when the monitoring unit is operating correctly, it sends a fault message to the control unit.

It is also advantageous for the monitoring unit to be subdivided, with a part being arranged in the control unit. Instead of a single fault bit, the measurement unit can then transmit the signal level as determined during the self-test, via the digital data link, to the control unit. In the part of the monitoring unit arranged there, it is possible in particular to check, including the measurement information obtained by the evaluation unit, whether on the one hand, the monitoring unit is still serviceable and on the other hand, whether the instantaneous values of the analog measurement signal are within the permissible limits. The latter check can otherwise not be carried out during the time period of the self-test.

### BRIEF DESCRIPTION OF THE DRAWING

Further features, advantages and details of the invention will become evident from the following description of exemplary embodiments, with reference to the drawing, in which:

FIG. 1 shows a first exemplary embodiment of a measurement arrangement having a measurement unit which has an optical sine/cosine transmitter and a monitoring unit, wherein a drive for the light sources of the sine/cosine transmitter is variable,

FIG. 2 shows a further exemplary embodiment of a measurement arrangement having a measurement unit which has a monitoring unit, wherein amplifiers with variable gain factors are connected upstream of the monitoring unit, and

FIG. 3 shows one exemplary embodiment of the variable gain-factor amplifiers used in the measurement arrangement shown in FIG. 2.

### DETAILED DESCRIPTION OF PREFERRED EMBODIMENTS

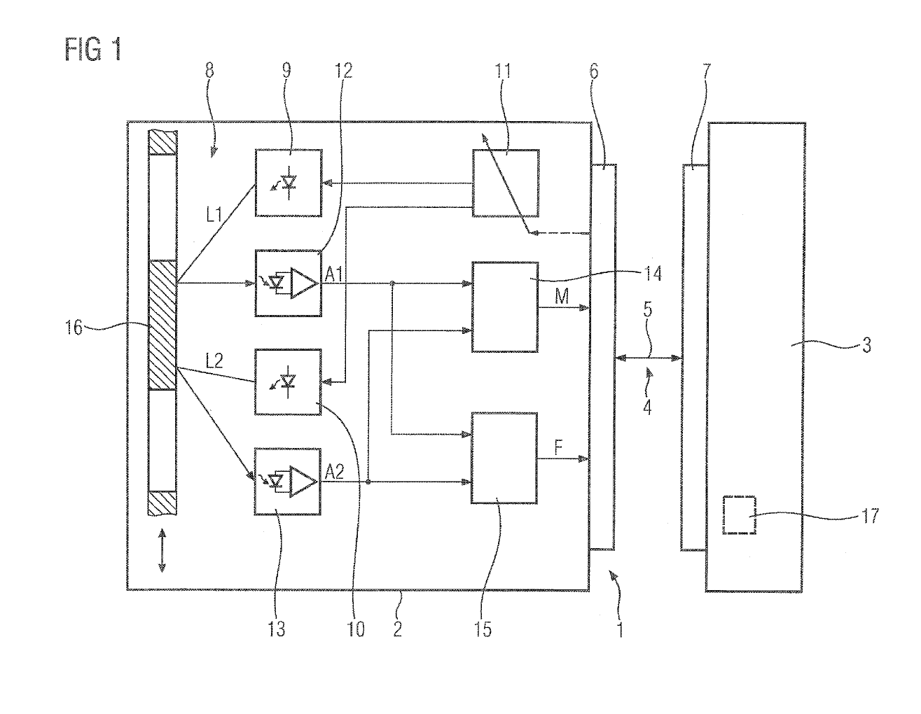

Mutually corresponding parts are provided with the same reference symbols in FIGS. 1 to 3.

FIG. 1 shows one exemplary embodiment of a measurement arrangement 1 for detection of a position of a moving part of a machine, which is not illustrated in any more detail. In particular, the machine may be a processing machine, such as a machine tool or a manufacturing robot, which is designed largely as required. However, it may also be only a part of a higher-level unit, such as its electrical drive. In principle, instead of detecting the position of the moving part, it is also possible to detect some other physical or chemical operating variable of the machine.

The main components of the measurement arrangement 1 are a measurement unit 2 and a control unit 3, which can communicate with one another by means of a bidirectional digital data link 4. In this case, the data link 4 may be cable-based or configured on a wire-free basis. In addition to the actual data channel 5 it comprises in each case a transmitting/receiving module 6 and 7, respectively, on the measurement unit 2 and the control unit 3.

As sensor means, the measurement unit 2 contains a two-channel optical sine/cosine transmitter 8, whose light sources 9 and 10 are connected to a light source drive unit 11. Photoreceivers 12 and 13 of the sine/cosine transmitter 8 are connected to an evaluation unit 14 and to a monitoring unit 15. The light source drive unit 11, the evaluation unit 14 and the monitoring unit 15 each have a data link to the transmitting/receiving module 6.

The method of operation and particular advantages of the measurement arrangement 1 will be described in more detail in the following text.

The two light sources 9 and 10 produce optical sample signals L1 and L2, respectively, which are transmitted in the direction of a track 16, which is in the form of a periodic measurement scale. The track 16 is applied to the moving part, which is not illustrated in more detail, of the processing machine, whose instantaneous position is intended to be detected. The optical sample signals L1 and L2 are detected after reflection on or after passing through the track 16 by the photoreceivers 12 and 13, respectively and are converted to respective analog measurement signals A1 and A2. On the basis of the normal method of operation of the optical sine/cosine transmitter 8, the analog measurement signals A1 and A2 are each sinusoidal signals, which are offset in phase through 90° with respect to one another.

The analog measurement signals A1 and A2 are supplied to the evaluation unit 14, which digitizes them and also determines a digital measurement signal M, which contains measurement information about the instantaneous position of the track 16, and therefore of the moving part of the processing machine. The digital measurement signal M is transmitted via the data link 4 to the control unit 3.

Furthermore, the analog measurement signals A1 and A2 are also fed as test signals into the monitoring unit 15, which checks whether both measurement signals A1 and A2 are within normal and permissible limits. For example, a lower and an upper threshold value may be preset. If this threshold value check shows that the permissible range has been undershot or overshot by one of the two analog measurement signals A1 or A2 or by a combination signal derived from these two analog measurement signals A1 and A2, a digital fault message F is generated and sent via the data link 4 to the control unit 3. In particular, the digital fault message F may be a single fault bit.

In the exemplary embodiment shown in FIG. 1, the monitoring unit 15 checks a combination signal which is obtained from the sum of the squares of the analog measurement signals A1 and A2, using:

sin²x+cos²x=1

this combination signal is a measure of the light intensities, provided on the input side, of the optical sample signals L1 and L2. These light intensities may be varied within certain limits by means of the light source drive unit 11. During normal operation, identical values which are predetermined at both light sources 9 and 10, are set for the light intensities of the optical sample signals L1 and L2.

The measurement unit 1 can be operated on request via the control unit 3 in a self-test mode. The serviceability of the monitoring unit 15 is checked during this self-test. For this purpose, the light source control unit 11, triggered by an appropriate control command from the control unit 13, sets the light intensities produced by the light sources 9 and 10 such that the combination signal checked in the monitoring unit 15 is below a lower threshold value or above an upper threshold value. If the monitoring unit 15 then does not transmit a fault message F to the control unit 3, the monitoring unit 15 is no longer operating correctly. The control unit 3 identifies this and initiates measures provided for a fault situation such as this.

In one alternative exemplary embodiment, instead of the fault message F which is in the form of a single bit, the level determined in the monitoring unit 15 is transmitted in digital form via the data link 4 to the control unit 3. In this alternative exemplary embodiment, the latter comprises in particular a part 17, which is illustrated by dashed lines in FIG. 1, of the monitoring unit 15. This allows two different checks to be carried out in the control unit 3. First of all, a check is carried out in the course of the self-test of the monitoring unit 15 to determine whether the threshold values are still correctly identified. On the other hand, a known relationship between the output response which occurs with the light intensities provided during normal operation and the output response which occurs with the light intensities provided in the self-test mode, is also used to check whether the analog measurement signals A1 and A2 would have complied with the threshold-value conditions during normal operation. This means that the self-test does not result in any gaps in the monitoring of the analog measurement signals A1 and A2.

The measurement arrangement 1 offers the further advantage that the light intensities of the optical sample signals L1 and L2 can be varied successively in order to check the lower and/or upper threshold value from which the monitoring unit 15 identifies a fault. If these threshold values vary over the course of time, this is identified at an early stage by means of the measurement arrangement 1 and the necessary steps can be initiated in good time.

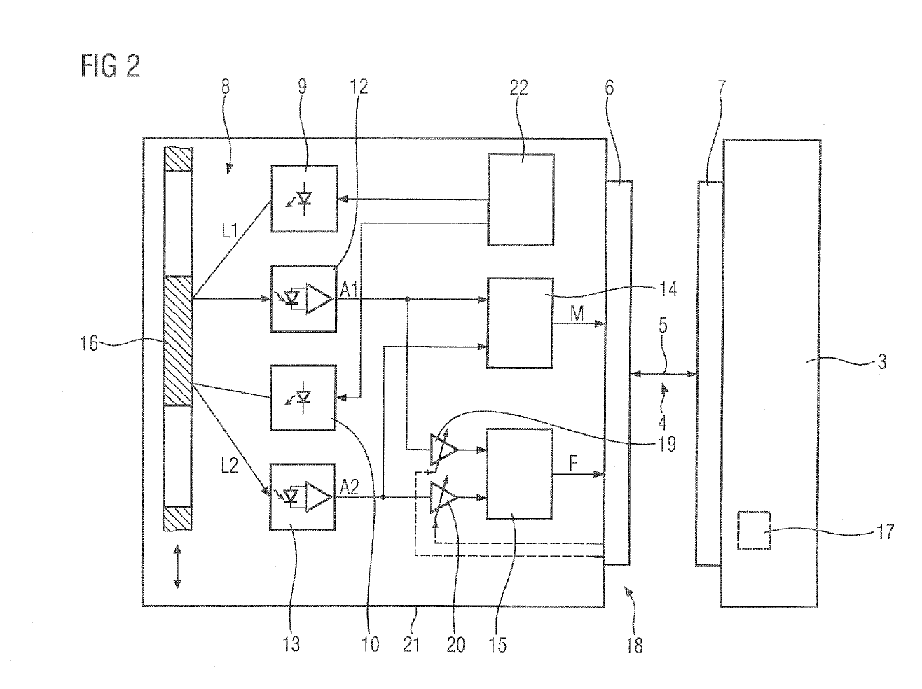

FIG. 2 shows a further exemplary embodiment of a measurement arrangement 18. This differs from the measurement arrangement 1 shown in FIG. 1 in that the attenuation or amplification of the analog measurement signals A1 and A2 which has been carried out during the self-test in order specifically to generate the test signals for the monitoring unit 15 is not carried out by varying the drive of the light sources 9 and 10. Instead of the variable light source drive unit 11, variable amplifiers 19 and 20 are provided as modification means in the measurement arrangement 18 and are connected on the input side, upstream of the monitoring unit 15. Otherwise, the design and method of operation of the measurement arrangement 18 correspond essentially to those of the measurement arrangement 1.

In addition to a somewhat differently designed measurement unit 21, the measurement arrangement 18 once again contains the data link 4 and the control unit 3. In contrast to the measurement unit 2 in the measurement arrangement 1, a light source drive unit 22 for the measurement unit 21 cannot be influenced by the control unit 3—at least not for self-test purposes. The digital control command generated by the control unit 3 in order to initiate the self-test in contrast, in the measurement arrangement 18, influences the variable amplifiers 19 and 20, in particular their respectively variable gain factors. This operative connection is indicated in FIG. 2 in the same way as the corresponding operative connection to the light source drive unit 11 for the measurement arrangement 1 as shown in FIG. 1, by means of dashed lines.

The other components of the measurement unit 21 are unchanged from the measurement unit 2.

The variable amplifiers 19 and 20 can also be used to raise or lower the levels of the analog measurement signals A1 and A2 which are supplied as test signals to the monitoring unit 15 during the self-test, to such an extent that the lower and/or upper threshold values stored in the monitoring unit 15 are respectively undershot or overshot, and the fault message F is sent.

The variable amplifiers 19 and 20 can also be designed such that the respective gain factor can be varied in a plurality of steps or else continuously. As already described in conjunction with the measurement arrangement 1, this makes it possible to find out the level values from which the monitoring unit 15 will currently respond.

An alternative exemplary embodiment is likewise possible in the refinement of the measurement arrangement 18 shown in FIG. 2, in which the part 17 of the monitoring unit 15 is arranged in the control unit 3. This option is once again indicated by the dashed lines of the part 17. As has already been described in conjunction with the measurement arrangement 1 as shown in FIG. 1, in this alternative exemplary embodiment, the level which is identified during the self-test mode is transmitted via the data link 4 to the measurement unit 3, in which a double check is carried out.

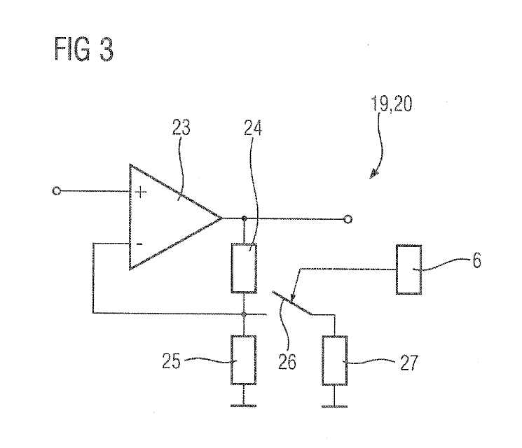

FIG. 3 shows one exemplary embodiment of a possible implementation of the variable amplifiers 19 and 20. An operational amplifier 23 with feedback is provided, and its output is connected in series with a first resistor 24 and a second resistor 25. The first resistor 24 is part of a feedback branch which feeds the output of the operational amplifier 23 back to the negative input. A parallel branch, which can be connected is connected to the second resistor 25 and comprises a switching element 26 and a parallel resistor 27. The switch position of the switching element 26 can be varied by the control command for initiating the self-test mode. The resistor constellation provided at the output of the operational amplifier 23 governs the gain factor of the respective amplifier 19 or 20, in a known manner. The gain factor can thus be influenced in the desired manner by connection or disconnection of the parallel resistor 27.

The embodiment shown in FIG. 3 should be regarded as an example. In principle, other amplifier circuits are also feasible. In particular, embodiments are also possible in which the gain factor can be switched between more than two different values.

Both the measurement arrangement 1 and the measurement arrangement 2 are distinguished by very high reliability. This is achieved in particular by the checking of the monitoring unit 15 that is carried out during the self-test mode. Faults that occur thus can be reliably identified, and signaled to the control unit 3. Even in the case of particularly safety-relevant applications, there is therefore no need to provide redundant measured-value detection with two measurement units 2 and 21 operated in parallel.

What is claimed is:

1. A method for testing functionality of an optical measuring device of a machine tool, comprising the steps of:
acquiring optical measurement signals and converting the acquired optical measurement signals into analog electrical signals,
supplying the analog electrical signals to an evaluation unit,
supplying the analog electrical signals as test signals to a monitoring unit,
performing, upon initiation by a control device of the machine tool, a self-test of the monitoring unit by adjusting the test signals supplied to the monitoring unit such that a combination signal formed from the test signals is below the lower or above the upper threshold limit,
checking, if an error signal is transmitted to the control device of the machine tool, when the combination signal is below the lower or above the upper threshold limit, and
indicating a malfunction of the monitoring unit if no error signal is transmitted.

2. The method of claim 1, wherein the test signals are adjusted by adjusting a light intensity producing the optical measurement signals.

3. The method of claim 1, wherein the test signals are adjusted by adjusting an amplification factor of the analog electrical signals supplied as test signals to the monitoring unit

4. The method of claim 1, wherein the error signal is transmitted to the control device as a single bit.

5. The method of claim 2, further comprising the steps of:
successively changing the light intensity, and
determining a light intensity level necessary to cause the monitoring unit to produce the error signal.

6. The method of claim 3, further comprising the step of:
successively changing the amplification factor, and
determining the amplification factor necessary to cause the monitoring unit to produce the error signal.
